(19) United States
(12) Patent Application Publication
(10) Pub. No.: US 2026/0212231 A1
(43) Pub. Date: Jul. 23, 2026

(54) PERTURBATION ANALYTICS OF MACHINE LEARNING MODELS

(71) Applicant: HEWLETT PACKARD ENTERPRISE DEVELOPMENT LP, Spring, TX (US)

(72) Inventors: Mantej Singh Gill, Bangalore (IN); Anil Babulal, Bangalore (IN); Tarun Kumar, Bangalore (IN); Dhamodhran Sathyanarayanamurthy, Bangalore (IN)

(21) Appl. No.: 19/178,548

(22) Filed: Apr. 14, 2025

(30) Foreign Application Priority Data
Jan. 21, 2025 (IN) 202541004788

(51) Int. Cl. G06N 5/045

(52) U.S. Cl. CPC G06N 5/045

(57) ABSTRACT

Systems and methods are provided for implement a perturbation technique of a subset of input time series data (e.g., a “motif”) provided to a machine learning model to help determine the effect of the motif on the inference of the model, absent any knowledge of the weights/biases corresponding with that particular motif in the input data. The replacement of the motif may be implemented to help describe the significance of a repeating pattern in the time series data with respect to its effect on the inference output.

### BACKGROUND

In an era characterized by the proliferation of sophisticated machine learning algorithms, machine learning models created by the machine learning algorithms have been deployed in numerous industries. These machine learning models are often deployed as a black box to a recipient user. For example, the recipient user may receive the machine learning model that is pre-trained on time series dataset, which is commonly found in fields such as finance, healthcare, and telemetry data of data centers deployed in various user environments. The recipient user in any of these industries may simply provide new time series dataset to the pre-trained machine learning model to utilize the inference/predictive properties of the model. This format of deploying black box models to users has become prevalent across diverse industries and applications.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is an illustrative computing component configured to implement a perturbation analysis of machine learning models, in accordance with examples discussed herein.

FIG. 2 illustrates a process of implement a perturbation analysis of machine learning models, in accordance with examples discussed herein.

FIG. 3 illustrates a motif similarity matrix, in accordance with examples discussed herein.

FIG. 4 illustrates a perturbation matrix, in accordance with examples discussed herein.

FIG. 5 illustrates a feature importance matrix, in accordance with examples discussed herein.

FIG. 6 illustrates a consistency matrix, in accordance with examples discussed herein.

FIG. 7 illustrates a normalized heat map with motifs, in accordance with examples discussed herein.

FIG. 8 illustrates a normalized heat map with motifs, in accordance with examples discussed herein.

FIG. 9 illustrates a set of normalized heat maps with different machine learning models, in accordance with examples discussed herein.

FIG. 10 is a computing component that may be used to implement examples of the disclosed technology.

FIG. 11 depicts a block diagram of an example computer system in which various examples of the disclosed technology described herein may be implemented.

The figures are not exhaustive and do not limit the present disclosure to the precise form disclosed.

### DETAILED DESCRIPTION

While these machine learning models exhibit remarkable predictive capabilities, understanding and interpreting the machine learning models can be challenging in light of their opacity. Additionally, several of these machine learning models are provided as a black box or as a service, where only the input is received and the inference/output is provided. In this type of system, the user may be unable to understand the rationale behind the predictions generated by the model, and thereby hinder the ability of the user to implement changes or take action based on the predictions.

To improve the interpretability and understandability of the model, time series dataset that is used to train and utilized for inferences may provide insights to the inner workings of the model. In some examples, prior to using the time series dataset as input to the black box model, the time series dataset can be provided to an unsupervised machine learning model to cluster the data into groups of data points that share similar characteristics or features. The clustering process can try to find these groups of data in data without the use of labels that place the data points in predetermined clusters.

Using these clusters, additional information can be determined. Particularly in time series dataset, the data often comprises recurring patterns or subsequences, known as “motifs.” Motifs represent similar sets of data points across a plurality of clusters in the time series dataset that can be regular behaviors, trends, or cyclic patterns. The motif may correspond with a pattern of time entries in the recurrent sequences of data entries that is repeated multiple times in the time series dataset. For instance, in daily temperature data, a motif might represent the typical rise and fall of temperatures within a day (e.g., when workers start and end their day in the building). In a data center environment, the repeating motif may be indicative of recurring computing workloads.

Multiple motifs may be identified in the time series dataset. A first motif may correspond with a first recurrent sequences of data entries, and a second motif in the same dataset may correspond with a different pattern of data entries than the recurrent sequence of data entries.

When a motif is identified in the data, the existence of the data pattern corresponding with the motif may have some effect on the weights/biases of the inference of the black box model (e.g., which were determined during the training phase of the model). For example, the model may be trained to infer a particular output based on a particular input provided by the series of data in the motif. When the subset or series of data are removed, the model may adjust the inference of the model because the weights/biases associated with the series of data in the motif are not present.

In accordance with examples of the disclosed technology, the system can implement a perturbation technique of an initial time series dataset to help determine the effect of the motif on the inference of the model, absent any knowledge of the weights/biases corresponding with that particular motif in the input data. The replacement of the motif may be implemented through a “perturbation” algorithm, process, or technique (used interchangeably) that replaces the motif with different data to create a time series perturbed dataset or perturbed dataset (used interchangeably). The perturbation technique may help describe the significance of a repeating pattern in the time series dataset (e.g., as the aforementioned motifs) with respect to its effect on the inference output by measuring the adjustment to the inference output as a result of removing/changing the motif in the input. This can also potentially influence the inference that is output by the machine learning model.

For example, the initial time series dataset with a motif may be provided to a trained machine learning model to generate a first prediction output of the initial time series dataset. The system can replace the motif in the data with a different motif of a “motif composition” (e.g., a data sequence of altered time series data reflecting variations in the motif, either as a set of data points, static/consistent value, noise, or other subset of data). The dataset comprising the motif composition that replaces a portion of the original dataset may generate a perturbed dataset. The perturbed dataset may be provided to the trained machine learning model to generate a second prediction output, which is compared with the first prediction output. An explanation of the comparison can be provided to the device or other interface.

The perturbation technique can follow several variations and implementations, including time-based perturbation, amplitude-based perturbation, and shape-based perturbation. In time-based perturbation, the process may systematically modify motifs within a time interval of a time series dataset to evaluate its influence on the machine learning model predictions. In amplitude-based perturbation, the process can systematically modify the amplitudes of a motif during each of its occurrences, one at a time, to evaluate its influence on machine learning model predictions. In shape-based perturbation, the process can systematically alter the shape of a motif wherever it occurs within a time series, simultaneously, to evaluate its influence on machine learning model predictions.

Various comparisons and explanations can be generated as well. For example, a perturbation matrix can record the changes in model predictions, using a distance metric (Euclidean distance) when different motifs in the time series data are perturbed or altered. Each row in the matrix corresponds to a motif from the test set, which is perturbed by distinct motifs from the training set, represented by columns. A feature importance matrix can quantify the significance of each motif or feature in influencing the model's predictions, summarizing the effect of perturbations on the model's forecasts. A consistency matrix can assess the consistency of model predictions when perturbed by the same motif. It is derived by normalizing the Perturbation Matrix column-wise and then aggregating it row-wise. A motif similarity matrix illustrates the Dynamic Time Warping (DTW) distance between each pair of motifs, providing insights into pattern variations. Various visual explanations can be generated and provided as well, including a heat map that can show artifacts in the data.

In some examples, the explanation corresponds with a local, global, or cross-model explanation. For example, a local explanation may comprise an explanation of the motif itself or the trained model itself, without an effect of the motif/model on other components of the distributed system. In a global explanation, the explanation of the trained machine learning model may comprise a textual or image-based explanation of the broader patterns, consistency, and generalization across datasets. In the cross-model explanation, the explanation may correspond with a consensus and divergence analysis where different models make notably different predictions, revealing potential variations in learned patterns or model uncertainty.

Technical improvements are found throughout the application. For example, the explanation/interpretation of the motif in the data can be provided to an interface, including whether the motif has a significant effect on the prediction. In a data center environment, the corresponding device that has a significant effect on the shape/motif in the data (e.g., in excess of a threshold) may be adjusted to reduce the frequency of the motif, or adjust the determination of the prediction being true. This can be implemented even when the machine learning model is provided as a black box to the recipient user. As such, the opacity of the model can be transmitted efficiently via a network to the user and the user can maintain an understanding of the model and how to adjust physical devices and processing (e.g., varying software workloads) based on the explanations that the system produces. The user is able to effectively manage and optimize their infrastructure to accommodate the cause and effect of the motifs.

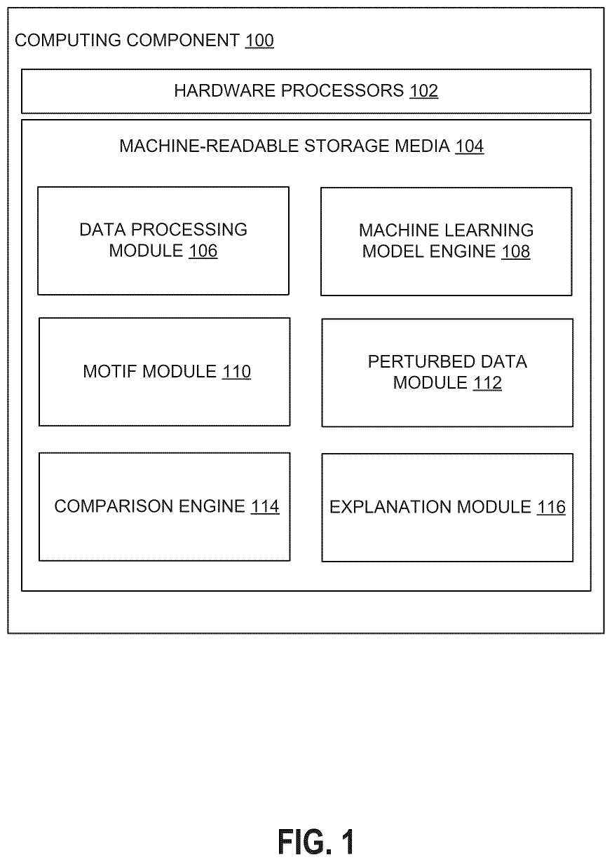

FIG. 1 is an illustrative computing component configured to implement a perturbation analysis of machine learning models, in accordance with examples discussed herein. For example, computing component 100 may be a server computer, a controller, or any other similar computing component capable of processing data from a client device received via a communication network.

In the example implementation of FIG. 1, the computing component 100 includes hardware processor 102 and machine-readable storage medium 104. Hardware processor 102 may include one or more electronic circuits that include electronic components for performing the functionality of one or more instructions, such as a field programmable gate array (FPGA), application specific integrated circuit (ASIC), or other electronic circuits. Machine-readable storage medium 104 may be any electronic, magnetic, optical, or other physical storage device that contains or stores executable instructions and may comprise several modules and engines configured to perform the operations discussed throughout the disclosure. Some modules in the illustrated example implementation include data processing module 106, machine learning model engine 108, motif module 110, perturbed data module engine 112, comparison engine 114, and explanation module 116.

Data processing module 106 is configured to receive an initial time series dataset generated by a device. The time series dataset may be received from a sensor of a monitored device and comprise various data signatures at different times. In some examples, the time series dataset may be provided as input to a machine learning model to generate an inference about the dataset (via machine learning model engine 108).

Machine learning model engine 108 is configured to receive time series data generated by a device, and provide the time series data as input to a trained machine learning model. The trained machine learning model may identify a pattern in the data as the first prediction output.

The machine learning model may be a decision tree, neural network, support vector machine, or other machine learning model or pattern detection algorithm that can detect patterns in the time series data generated by the device. In each of these examples, machine learning model engine 108 may preprocess the time series data by cleaning it (e.g., remove duplicates and outliers in the data) and encoding the data to convert categorical variables into numerical format. In some examples, machine learning model engine 108 may also standardize the data by scaling the numerical features along a relative/common range.

When a decision tree is implemented, machine learning model engine 108 may generate the tree through a training process after the data is preprocessed. First, machine learning model engine 108 may determine a splitting criterion for the decision tree. The splitting criterion may comprise a Gini impurity or entropy for classification tasks, and mean squared error for regression tasks. In some examples, recursive splitting is implemented for the decision tree. In this instance, machine learning model engine 108 may start from the root node and split the dataset based on the feature that results in the best split according to the chosen criterion. Machine learning model engine 108 may repeat the splitting recursively for each child node until stopping conditions are met (e.g., maximum depth, minimum samples per leaf, or no further improvement). After building the tree, machine learning model engine 108 may prune the tree by removing branches that have little importance or that do not provide predictive power in excess of a threshold value.

In some examples, the parameters of the tree may be optimized through a hyperparameter tuning process. The process may vary by implementation. Some parameters that may be optimized during the hyperparameter tuning process include maximum depth, minimum samples per leaf, and splitting criteria using techniques like grid search or random search to improve model performance.

When a neural network is implemented as the first machine learning model, machine learning model engine 108 may define the structure of the network, including the number of layers, types of layers (e.g., dense, convolutional, recurrent), and the number of neurons in each layer during a training process after the data are preprocessed. Other features of the neural network may also be determined, including the activation functions for each layer of the neural network (e.g., ReLU, sigmoid, softmax), loss function (e.g., categorical cross-entropy for classification), optimization algorithm to update weights during training (e.g., SGD), and metrics to monitor model performance (e.g., accuracy, precision).

In some examples, the neural network may be trained through a series of steps executed by machine learning model engine 108. The training process may comprise a forward pass (e.g., input data is fed through the network, producing an output), loss calculation (e.g., compare the predicted output with the true labels), backpropagation (e.g., calculate gradients of the loss with respect to the model's weights), and update the weights using the optimizer based on the computed gradients. The forward and backward pass may be repeated for a specified number of epochs.

When a support vector machine (SVM) is implemented as the machine learning model, machine learning model engine 108 may choose the appropriate kernel function based on the format of the metrics being analyzed in the data generated by the device (e.g., linear kernel, polynomial kernel, or Radial Basis Function (RBF) kernel). Machine learning model engine 108 may formulate the optimization problem to maximize the margin between the classes while minimizing classification errors, and identify the support vectors (e.g., the data points that are located closest to the decision boundary). Using this information, the training may implement hyperparameter tuning, which implements a grid search or random search to find optimal values for the parameters of the model.

Using any of the decision tree, neural network, support vector machine, or other machine learning model or pattern detection algorithm as the machine learning model, machine learning model engine 108 may detect patterns in the time series data. The patterns may align with computational activities at the device that are repeated and detectable via the analysis.

Motif module 110 is configured to determine a motif corresponding to a recurrent sequence of data. The motif may be determined using a pattern detection algorithm or machine learning model that are trained to identify similarities of contiguous data points in a dataset. For example, the system may implement an unsupervised machine learning model that is trained to identify and group a contiguous set of data points of the time series data into a first cluster. The unsupervised machine learning model may match the data signatures in order to form the motif (e.g. using a K-Means algorithm or other clustering algorithm). The unsupervised machine learning model may be trained to identify a pattern of data points using a clustering algorithms (e.g., k-means, DBSCAN, hierarchical clustering, and the like) configured to group similar events in the data.

The motifs may be identified by motif module 110 within both training and test datasets as recurrent sub-sequences in time series data. The motifs may be interpretable insights that can provide a deeper understanding of time series data, because they are repeatable and detectable patterns that motif module 110 can predict to recur.

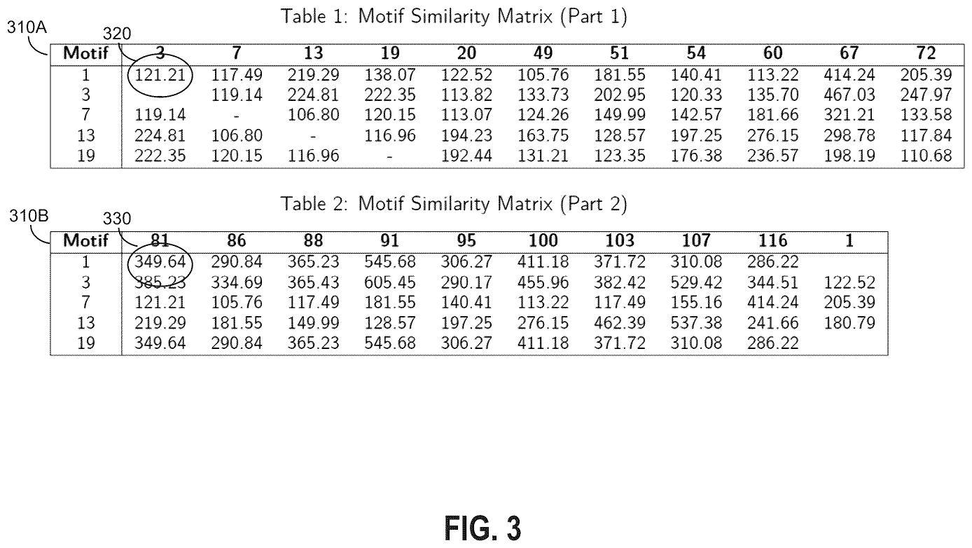

In some examples, motif module 110 is configured to implement a Dynamic Time Warping (DTW) algorithm to measure the similarity between recurrent sub-sequences in time series data. In measuring the similarity, motif module 110 may use the DTW algorithm to construct a Motif Similarity Matrix to measure the motif similarity. An illustrative Motif Similarity Matrix is provided with FIG. 3.

For example, the Motif Similarity Matrix may compute the DTW distance between each pair of motifs. The distance may be compared with a threshold value to identify similar motifs (e.g., in excess of the threshold) or dissimilar motifs (e.g., less than the threshold). The comparison assessment may provide a quantitative basis for perturbing motifs and assessing model robustness, as well as providing insight into pattern variations.

In some examples, motif module 110 may assign an identifier to the motif and also assign an identifier to the perturbed dataset in response to the perturbed data module engine 112 replacing the motif in the dataset. The identifier of the motif may be identified as being replaced as well.

Perturbed data module engine 112 is configured to replace the recurrent sequence of data entries corresponding with the motif with a motif composition. The motif composition may correspond with a subset of data in the time series data (e.g., identified by the DTW algorithm or other pattern recognition process) that is generated to form a different subset of values in the dataset than the motif.

The perturbation technique can follow several variations and implementations, including time-based perturbation, amplitude-based perturbation, and shape-based perturbation to help contribute to the model forecast's explainability. For example, time-based perturbation involves systematically modifying motifs within a time interval of a time series dataset to evaluate its influence on the machine learning model predictions. In amplitude-based perturbation, the process can systematically modify the amplitudes of a motif during each of its occurrences, one at a time, to evaluate its influence on machine learning model predictions. In shape-based perturbation, the process can systematically alter the shape of a motif wherever it occurs within a time series, simultaneously, to evaluate its influence on machine learning model predictions

As an illustrative example of shape-based perturbation, the motif may resemble a V-shape and the motif composition may resemble an M-shape. When corresponding with a shape of the subset of data along a timeline of time series data, the motif may correspond with a first shape and the motif composition may correspond with a second shape that is different than the first shape. The replacement of the motif with the motif composition may generate a perturbed dataset comprising a subset of the time series data and the motif composition.

In another example of shape-based perturbation, the time series data may comprise subsets of data points that resemble shapes, like a circle, a triangle, and a rectangle. Each subset of data point may correspond with a subset of data in the time series data generated by the device. These patterns may be determined by the pattern detection algorithm (e.g., via motif module 110). The perturbation of the time series data may replace all the circles (e.g., first motif) with the triangles (e.g., second motif or motif composition). This may create a shape-based pattern in the perturbed dataset as a triangle, a triangle, and a rectangle, whereas the original time series data may include a circle, a triangle, and a rectangle. The original dataset and the perturbed dataset may both be provided (e.g., sequentially or in parallel) to the same trained machine learning model to generated prediction outputs. The differences in the prediction outputs may be attributed to the changes in the input datasets.

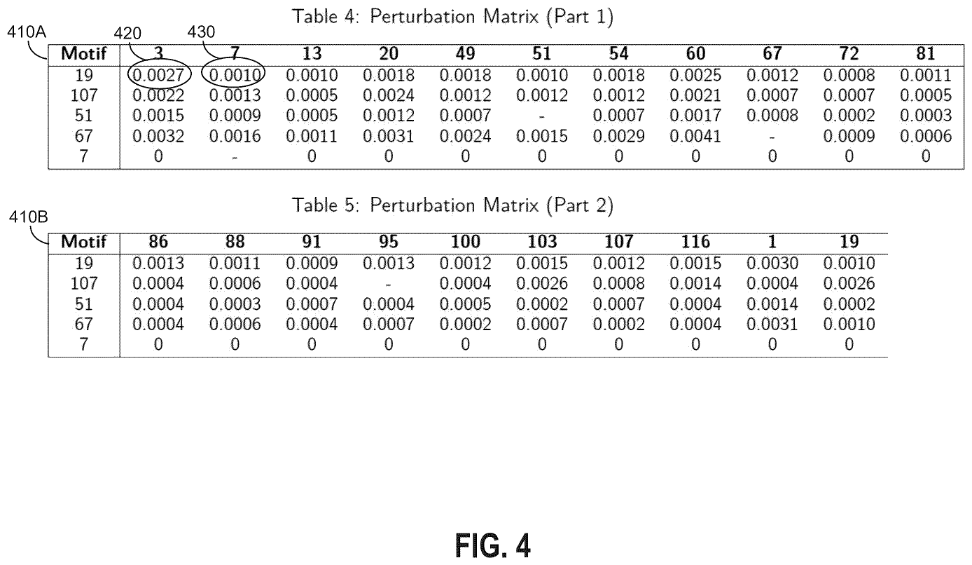

The perturbed dataset may be generated using a perturbation matrix that specifically addresses the impact of motifs. The Perturbation Matrix can record the changes in model predictions, using a distance metric (Euclidean distance) when different motifs in the time series data are perturbed or altered. Each row in the matrix corresponds to a motif from the test set, which is perturbed by distinct motifs from the training set, represented by columns. An illustrative Motif Similarity Matrix is provided with FIG. 4.

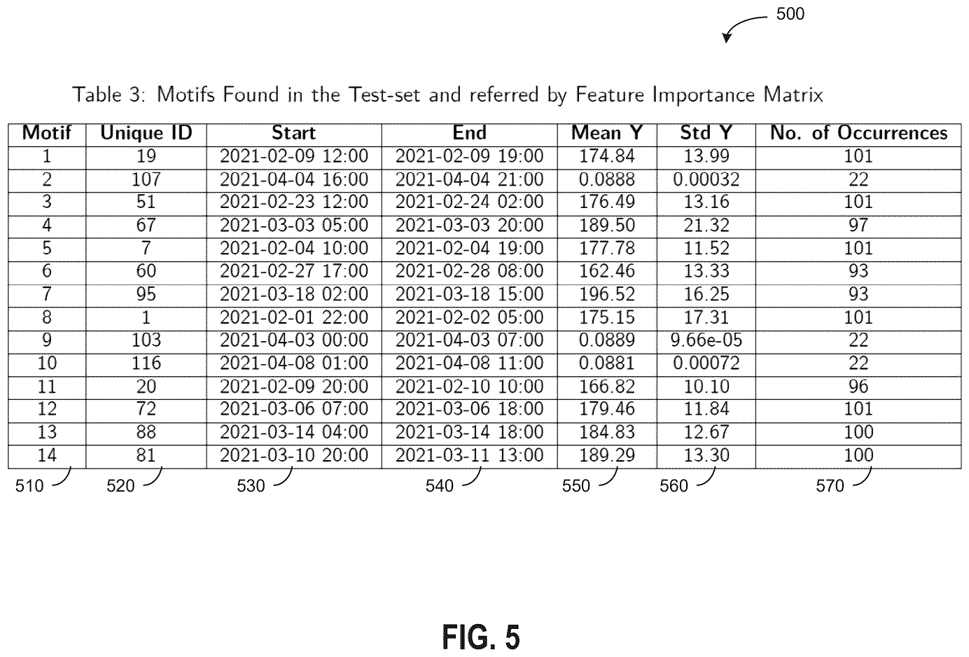

The perturbation matrix may be used to generate other structured explanation artifact such as a Feature Importance matrix. For example, a Feature Importance Matrix can quantify the significance of each motif or feature in influencing the model's predictions, summarizing the effect of perturbations on the model's forecasts. In some examples, the feature importance matrix may comprise detailed information about each motif, including its time duration, mean, standard deviation, frequency, and closest members in the dataset. An illustrative feature importance matrix is provided in FIG. 5.

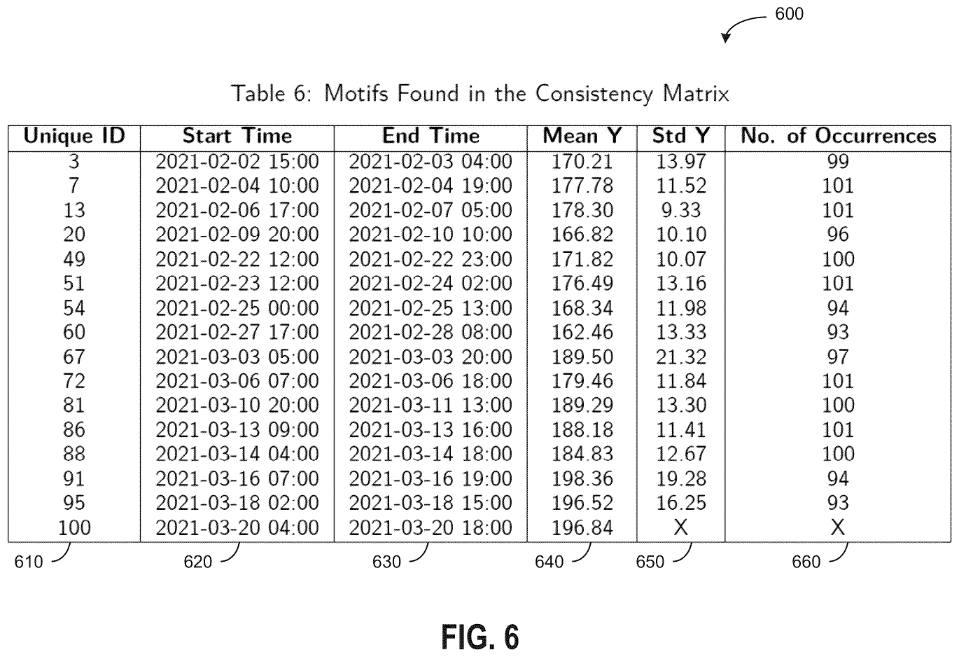

The perturbation matrix may be used to generate other structured explanation artifact such as a consistency matrix. A Consistency Matrix can assess the consistency of model predictions when perturbed by the same motif. It is derived by normalizing the Perturbation Matrix column-wise and then aggregating it row-wise, using summation as the chosen aggregation method. Detailed information about each motif, including its time duration, mean, standard deviation, frequency, and closest members in the dataset. An illustrative feature importance matrix is provided in FIG. 6.

Perturbed data module engine 112 is also configured to systematically perturb a single motif from the dataset to generate a perturbed dataset and provide the perturbed dataset to the machine learning model. The perturbed dataset may be provided to machine learning model engine 108 as input to a trained machine learning model. The trained machine learning model may generate an inference/output based on the perturbed dataset as the second prediction output.

Comparison engine 114 is configured to compare the first prediction output (using the original dataset from the user device) with the second prediction output (using the perturbed dataset). This can help analyze the impact on the model's output and determine the sensitivity and robustness of the model to specific motif/patterns. For example, comparison engine 114 may access the perturbation matrix and compare the first prediction output with the second prediction output using a distance metric (Euclidean distance).

Other perturbation analysis may be accessed as well, including the feature importance matrix and the consistency matrix. The comparison may be relative to other comparisons, such that the greater delta/difference value in one comparison may cause a greater effect on the data than another comparison.

Explanation module 116 is configured to determine and provide an explanation of the comparison to the device. The explanations may comprise various levels of specificity, including local explanations, global explanations, and cross-model explanations. Local explanations may comprise a textual or image-based explanation of the impact of individual motifs through sensitivity and robustness analyses. Global explanations may comprise a textual or image-based explanation of the broader patterns, consistency, and generalization across the datasets. Cross-model explanations may comprise a comparison between multiple models to identify consensus patterns and divergence.

In local explanations, explanation module 116 may generate values for the sensitivity, robustness, and the interpretation of influential patterns within the model. For a sensitivity and robustness analysis, explanation module 116 may identify influential patterns using the feature importance matrix in excess of a threshold value. Explanation module 116 may analyze robustness by identifying the impact on inference to clarify how perturbed datasets effect/impact the predictions.

In global explanations, explanation module 116 may generate values related to the pattern consistency and generalization of the comparison of the original dataset to the perturbed dataset. For pattern consistency, explanation module 116 can quantify the consistency using the consistency matrix, which assesses the consistency of model predictions when perturbed by the same motif. High values in this matrix (e.g., values in excess of a threshold value) may indicate that the model consistently predicts outcomes for similar patterns, demonstrating its reliability.

For pattern generalization, explanation module 116 can quantify the pattern by measuring the ability of the model to consistently handle similar patterns, as measured by the consistency matrix. The model's consistency across similar patterns demonstrates effective pattern generalization.

In cross-model explanations, explanation module 116 may generate cross-model explanations that assess the model interpretability and transparency. Since the model is a black-box model, the behavior of the model may be identified by analyzing the output of the model that may illustrate the weights/biases or other trained features of the model. Cross-model explanations can involve the analysis and comparison of the predictive behavior of these models to gain insights into their decision-making processes. The cross-model explanations may use different feature matrices generated by various models (e.g., RNN, CNN, LSTM, and another machine learning models) to illustrate consensus patterns and generate a divergent analysis.

In the consensus patterns of cross-model explanations, explanation module 116 may determine segments of data for which multiple models provide similar predictions. These regions in the data can signify instances where different models, despite their architectural differences, can generate similar inferences/outcomes. In other words, consensus patterns can highlight areas of robust and consistent model behavior across a variety of model architectures.

In the divergence analysis of cross-model explanations, explanation module 116 may determine the motifs where different models make notably different predictions, revealing potential variations in learned patterns or model uncertainty.

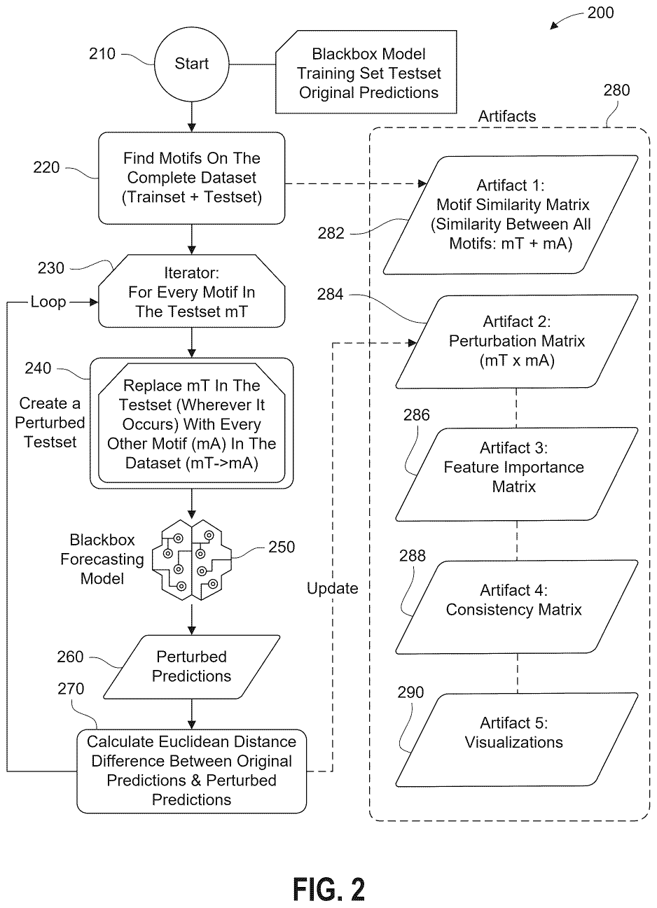

FIG. 2 illustrates a process of implement a perturbation analysis of machine learning models, in accordance with examples discussed herein. In example 200, the system may implement the process.

At block 210, the process may start with a black box machine learning model, training data set, a test dataset, and a set of original predictors.

At block 220, the process may determine motifs in the initial dataset. The initial dataset may comprise a training dataset and a test dataset.

At block 230, the process may implement an iterative process for every motif in the test dataset.

At block 240, the process may create a perturbed dataset. The perturbed dataset may comprise data that replaces the motif in the test dataset with a second motif or motif composition. In some examples, every instance of the motif may be replaced with the second motif or the motif composition.

At block 250, the process may provide the perturbed dataset to the machine learning model.

At block 260, the process may identify the perturbed predictors in the inference output generated by the machine learning model.

At block 270, the process may calculate a similarity (e.g., Euclidean distance) between the original inference/prediction and the prediction generated with the perturbed dataset.

At block 280, the process may generate various output that may be used to generate an explainability of the machine learning model (block 250). The output may comprise, for example, motif similarity matrix (block 282), perturbation matrix (block 284), feature importance matrix (block 286), consistency matrix (block 288), and visualizations like heat maps or charts (block 290).

FIG. 3 illustrates a motif similarity matrix 310, in accordance with examples discussed herein. In this example, motif similarity matrix 310 is provided with a set of motifs that are identified in the time series data (illustrated as first portion of motif similarity matrix 310A and second portion of motif similarity matrix 310B). The motifs are each assigned identifiers that are organized in motif similarity matrix 310 (e.g., Motif 1, Motif 3, Motif 7, Motif 13, Motif 19, etc.). Motif similarity matrix 310 may measure a motif similarity by computing the Dynamic Time Warping (DTW) distance between each pair of motifs, which can provide insights into pattern variations.

For example, when a first motif is substituted with a second motif, the system may provide the perturbed dataset to the machine learning model and calculate a significance value that is attributed to the changed motif. For example, significance value 320 is calculated by replacing Motif 1 with Motif 3. In another example, significance value 330 is calculated by replacing Motif 1 with Motif 81. The greater the significance value, the greater the effect that the particular motif has on the inference output. In this example, Motif 81 will have a greater effect on the significance of the inference than Motif 1 or Motif 3.

FIG. 4 illustrates a perturbation matrix 410, in accordance with examples discussed herein. In this example, perturbation matrix 410 is provided with a set of motifs that are identified in the time series data (illustrated as first portion of perturbation matrix 410A and second portion of perturbation matrix 410B). The motifs are each assigned identifiers that are organized in perturbation matrix 410. Perturbation matrix 410 records the changes in model predictions, using a distance metric (e.g., Euclidean distance) when different motifs in the time series datasets are perturbed or altered. Each row in the matrix corresponds to a motif from the dataset, which is perturbed by distinct motifs from the training set, represented by columns.

In a first illustration, perturbation matrix 410 shows the changes in model predictions when Motif 19 is replaced with Motif 3 at block 420 (e.g., 0.0027). In a second illustration, perturbation matrix 410 shows the changes in model predictions when Motif 19 is replaced with Motif 7 at block 430 (e.g., 0.0010). In other words, the first prediction output that generates a first inference included Motif 19 in the input time series dataset and the second prediction output that generates a second inference included Motif 3 in block 420 and included Motif 7 in block 430. The incremental changes in the inference/prediction are shown be the changes in the distance metric between the two value.

FIG. 5 illustrates an example set of motifs 500 that are found from the feature importance matrix, in accordance with examples discussed herein. Various data are included with the example set of motifs 500. For example, the set of motifs 500 may correspond with motif number 510, unique motif identifier 520, start time 530 and end time 540 (e.g., in the initial time series dataset), mean value 550, standard deviation value 560, and number of occurrences 570 (e.g., in the initial time series dataset). The feature importance matrix may use the example set of motifs 500 to quantify the significance of each motif or feature in influencing the model's predictions. The significance value may help summarize the effect of the perturbations on the model's inferences/predictions.

Feature importance matrix may be generated based on the perturbation matrix (e.g., illustrated in FIG. 4) and the significant time series may correspond with a motif in the dataset. For example, the system can implement a column-wise normalization and subsequent row-wise aggregation on the perturbation matrix, with summation as the chosen aggregation method.

FIG. 6 illustrates a consistency matrix 600, in accordance with examples discussed herein. The consistency matrix 600 can include, for example, a unique motif identifier 610 (corresponding with unique motif identifier 520 in FIG. 5), start time 620 and end time 630 (corresponding with start time 530 and end time 540 in FIG. 5), mean value 640 (corresponding with mean value 550 in FIG. 5), standard deviation value 650 (corresponding with standard deviation value 560 in FIG. 5), and number of occurrences 660 (corresponding with number of occurrences 570 in FIG. 5).

Consistency matrix 600 may help identify the consistency of model predictions when perturbed by the same motif. High values in this matrix (e.g., values in excess of a threshold value) may indicate that the model consistently predicts outcomes for similar patterns, demonstrating its reliability. For example, Motifs 3, 7, and 13 exhibit high consistency values, indicating effective pattern capture.

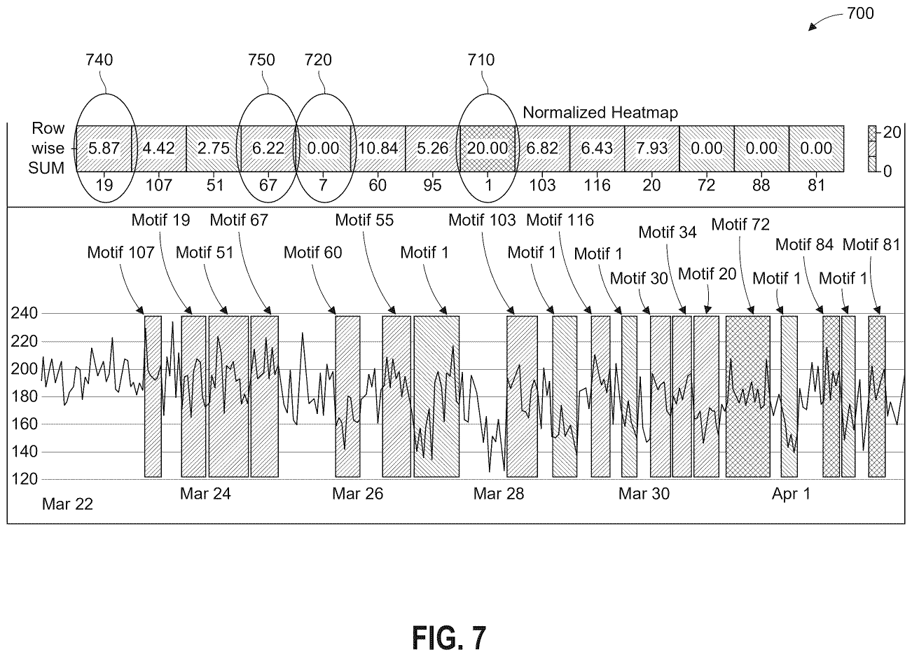

FIG. 7 illustrates a normalized heat map 700 with motifs, in accordance with examples discussed herein. The normalized heat map 700 may be shown in both a horizontal chart and a time series chart format. In this example, local explanations are provided, which generate values for the sensitivity, robustness, and the interpretation of influential patterns within the model. The intensity of the color may also correspond with the explanation of the motif with respect to other motifs in the dataset (e.g., darker color has more sensitivity/effect on the inference/prediction).

For instance, Motif 1 (block 710) has a significance value of 20.00, which is indicative of relatively high sensitivity when compared with the other motifs identified in the dataset. Motif 1 may have a significant influence on the model's predictions. In contrast, Motif 7 (block 720) has a significance value of 0.00, which is relatively low sensitivity. Motif 7 is considered robust and has minimal impact on the inference/predictions of the model.

In interpreting local explanations, Motif 1 (block 710) may stand out as highly influential, with minor perturbations resulting in significant changes. In contrast, Motif 7 (block 720) demonstrates robustness, where perturbations have minimal impact. Motifs 95, 116, and 19 exhibit a moderate level of influence, while Motifs 60 and 67 exert a notable influence on the model's predictions.

Based on these explanations, several inferences can be generated, including that Motif 1 (block 710) emerges as a pivotal and highly sensitive factor, in contrast to the robust and less influential nature of Motif 7 (block 720). Motifs 60 and 67 exert a significant influence, whereas Motifs 95 and 116 demonstrate a moderate impact. Motif 19 falls within the category of moderately influential motifs. These insights enrich our comprehension of how motifs influence the model's predictions.

For pattern generalization, the system may identify motifs where the model may consistently handle similar patterns (e.g., as measured by the consistency matrix in FIG. 6). The model's consistency across similar patterns demonstrates effective pattern generalization. For instance, Motif 19 (block 740) and Motif 67 (block 750) show consistent predictions for similar patterns, suggesting robust pattern generalization. These regions in the data can signify instances where different models, despite their architectural differences, tend to agree on the expected outcomes.

In other words, consensus patterns highlight areas of robust and consistent model behavior across a variety of model architectures. For example, for Motif 19 (block 740) and Motif 67 (block 750), although the absolute predictions differ among models, both Motifs predict relatively high values for all machine learning models. This consistency across models in predicting high values for these data points suggests a consensus pattern in the dataset.

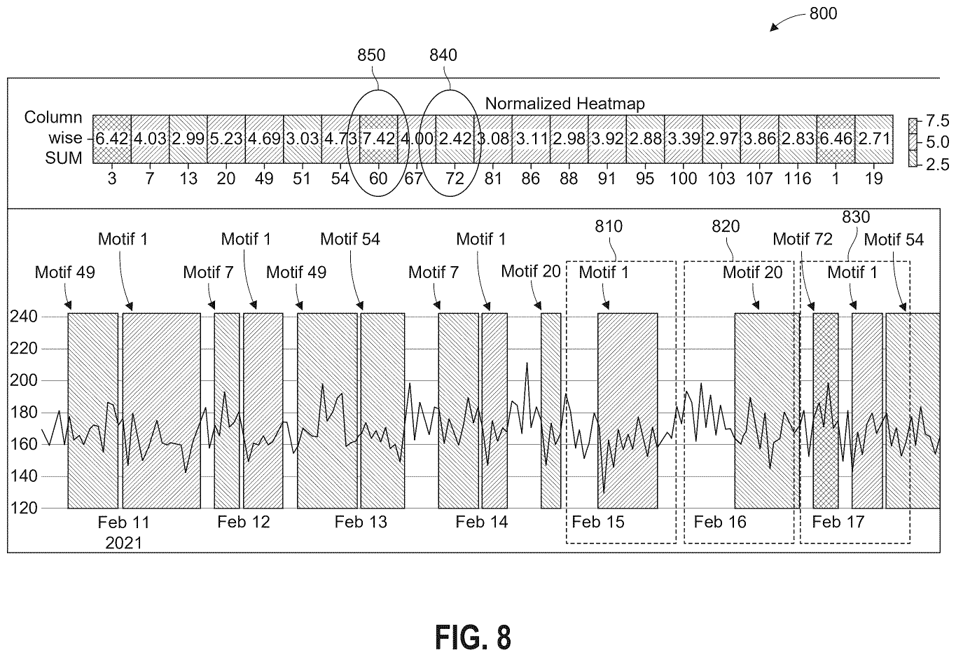

FIG. 8 illustrates a normalized heat map 800 with motifs, in accordance with examples discussed herein. As illustrated in FIG. 8, the consistency matrix may be modeled in a heat map format to show the consistency of the motif across model predictions. The darker colors may show a higher consistency relative to other motifs (e.g., in excess of a threshold value). The consistency matrix may be generated by normalizing the perturbation matrix column-wise and then aggregating it row-wise.

In some examples, the significant time periods may be highlighted by identifying the motifs and implementing the perturbed dataset. For example, February 15^{th} (block 810) may be more significant than February 16^{th} (block 820) or February 17^{th} (block 830) because subsets of the time period corresponding with motifs may have a greater contribution to the inference/prediction, as evidenced by the darker colors in the heat map. The intensity of the color may also correspond with the explanation of the motif with respect to other motifs in the dataset (e.g., darker color has more sensitivity/effect on the inference/prediction). For example, Motif 72 (block 840) corresponds with a low sensitivity/effect on the inference/prediction with respect to a threshold value and Motif 60 (block 850) corresponds with a high sensitivity/effect on the inference/prediction with respect to the threshold value.

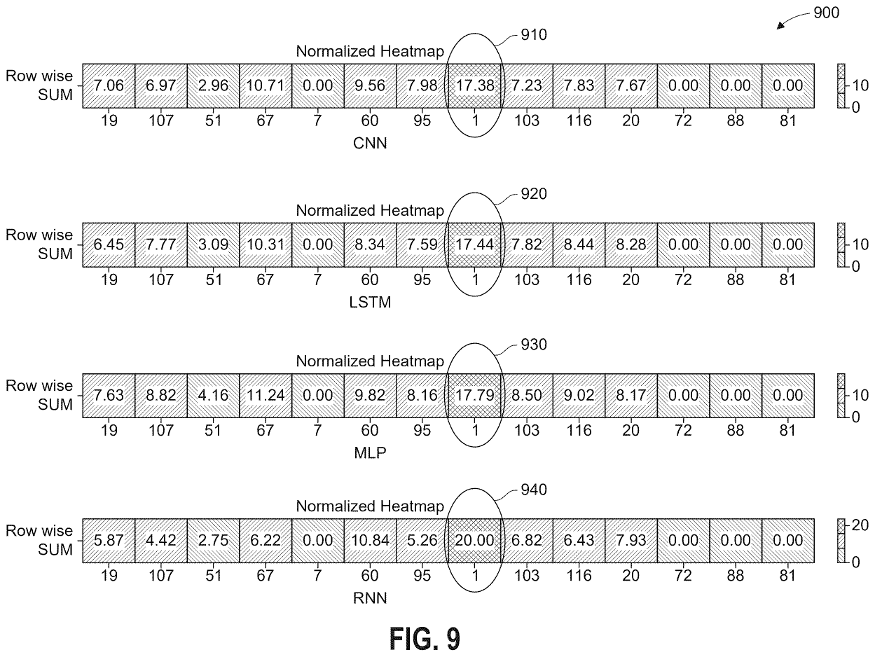

FIG. 9 illustrates a set of normalized heat maps with different machine learning models 900, in accordance with examples discussed herein. For each of the set of normalized heat maps with different machine learning models 900, motifs are determined from the initial time series dataset and the perturbed dataset, both of which are provided as input provided to multiple machine learning models. The differences in significance values for the motifs may be used to help explain different models. The explanations may be used in a divergence analysis of cross-model explanations. Where different models make different predictions, the system may identify potential variations in the models using learned patterns or model uncertainty.

Various machine learning models may be analyzed. The machine learning models may be black box models. The models may be trained and the trained models may receive input data (e.g., the original time series dataset or the perturbed dataset) to generate the inference/output. The models may include, for example, Convolutional Neural Network (CNN), Long Short-Term Memory (LSTM), Multilayer Perceptron (MLP), and Recurrent Neural Network (RNN).

For example, Motif 1 is identified in the time series data that is provided to four different machine learning models, including CNN (first motif 910), LSTM (second motif 920), MLP (third motif 930), and RNN (fourth motif 940). Significant prediction disparities exist across the models for Motif 1, especially at index 1. When this explanation is provided to the user device, the action taken in response to the distinctions may warrant further investigation to uncover the reasons for contrasting model predictions, providing insights into model strengths, weaknesses, and improvement areas.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

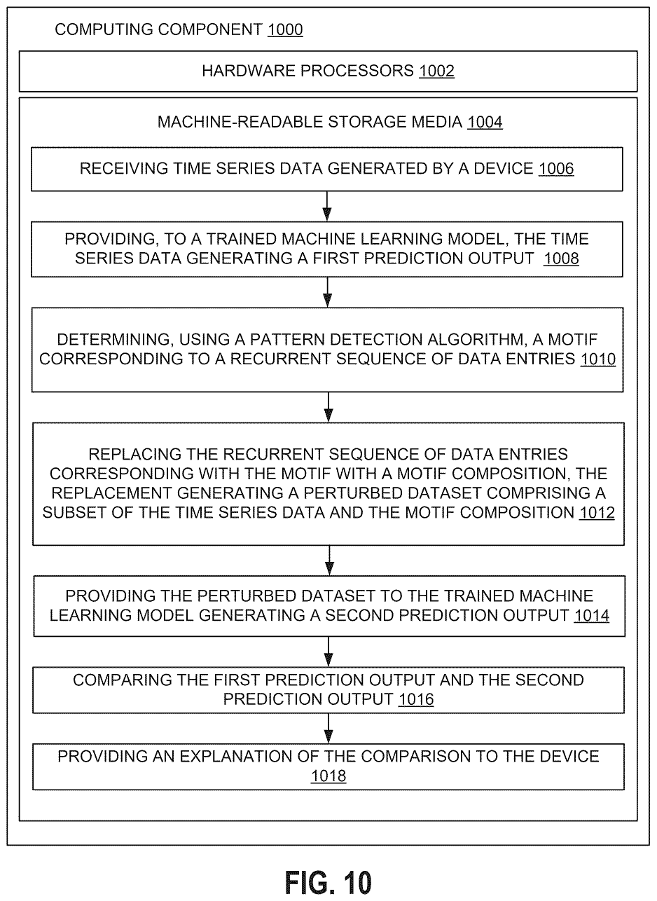

FIG. 10 illustrates a computing component that may be used to implement a perturbation analysis of machine learning models, in accordance with various examples of the disclosed technology. For example, computing component 1000 may be, for example, a server computer, a controller, or any other similar computing component capable of processing data. In the example implementation of FIG. 10, the computing component 1000 includes hardware processor 1002 and machine-readable storage medium 1004.

Hardware processor 1002 may be one or more central processing units (CPUs), semiconductor-based microprocessors, and/or other hardware devices suitable for retrieval and execution of instructions stored in machine-readable storage medium 1004. Hardware processor 1002 may fetch, decode, and execute instructions, such as instructions 1006-1018, to control processes or operations for implementing a perturbation analysis of machine learning models. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1018.

Hardware processor 1002 may execute instruction 1006 to receive time series data generated by a device. The time series dataset may be associated with data in fields such as finance, healthcare, and telemetry data of data centers deployed in various user environments.

Hardware processor 1002 may execute instruction 1008 to provide, to a trained machine learning model, the time series data. The trained machine learning model may generate a first prediction output of the time series data.

In some examples, the trained machine learning model is trained on a time series dataset that is different than the time series data that is provided by a different device. The trained machine learning model may be provided as a black box or as a service, where only the input is received and the inference/output is provided.

Hardware processor 1002 may execute instruction 1010 to determine, using a pattern detection algorithm, a motif corresponding to a recurrent sequence of data entries. The motif may comprise similar sets of data points across a plurality of clusters in the time series dataset that can be regular behaviors, trends, or cyclic patterns. When a motif is identified in the data, the existence of the data pattern corresponding with the motif may have some effect on the weights/biases of the inference of the black box model (e.g., which were determined during the training phase of the model). For example, the model may be trained to infer a particular output based on a particular input provided by the series of data in the motif. When the subset or series of data are removed, the model may adjust the inference of the model because the weights/biases associated with the series of data in the motif are not present.

Hardware processor 1002 may execute instruction 1012 to replace the recurrent sequence of data entries corresponding with the motif with a motif composition. The replacement may generate a perturbed dataset comprising a subset of the time series data and the motif composition.

The perturbation technique can follow several variations and implementations, including time-based perturbation, amplitude-based perturbation, and shape-based perturbation. In time-based perturbation, the process may systematically modify motifs within a time interval of a time series dataset to evaluate its influence on the machine learning model predictions. In amplitude-based perturbation, the process can systematically modify the amplitudes of a motif during each of its occurrences, one at a time, to evaluate its influence on machine learning model predictions. In shape-based perturbation, the process can systematically alter the shape of a motif wherever it occurs within a time series, simultaneously, to evaluate its influence on machine learning model predictions.

Hardware processor 1002 may execute instruction 1014 to provide the perturbed dataset to the trained machine learning model. The trained machine learning model may generate a second prediction output based on the perturbed dataset. In some examples, the trained machine learning model is the same model as associated with instruction 1008 and is not additional trained or adjusted by updating the weights/biases. In other words, the initial time series dataset may be provided to the same version of the model that the perturbed dataset is provided.

Hardware processor 1002 may execute instruction 1016 to compare the first prediction output and the second prediction output. The comparison of the original dataset with the perturbed dataset may help describe the significance of a repeating pattern in the time series with respect to its effect on the inference output. For example, the comparison may help measure the adjustment to the inference output as a result of removing/changing the motif in the input. This can also potentially influence the inference that is output by the machine learning model.

The use of different perturbation techniques can help determine the effect of the motif on the inference of the model, absent any knowledge of the weights/biases corresponding with that particular motif in the input data. The perturbation technique replaces the motif with different data (e.g., motif composition) to create a time series perturbed dataset and reuses some of the original dataset.

Hardware processor 1002 may execute instruction 1018 to provide an explanation of the comparison to the device. Various comparisons and explanations can be generated. For example, a perturbation matrix can record the changes in model predictions, using a distance metric (Euclidean distance) when different motifs in the time series data are perturbed or altered. Each row in the matrix corresponds to a motif from the test set, which is perturbed by distinct motifs from the training set, represented by columns. A feature importance matrix can quantify the significance of each motif or feature in influencing the model's predictions, summarizing the effect of perturbations on the model's forecasts. A consistency matrix can assess the consistency of model predictions when perturbed by the same motif. It is derived by normalizing the Perturbation Matrix column-wise and then aggregating it row-wise. A motif similarity matrix illustrates the Dynamic Time Warping (DTW) distance between each pair of motifs, providing insights into pattern variations. Various visual explanations can be generated and provided as well, including a heat map that can show artifacts in the data.

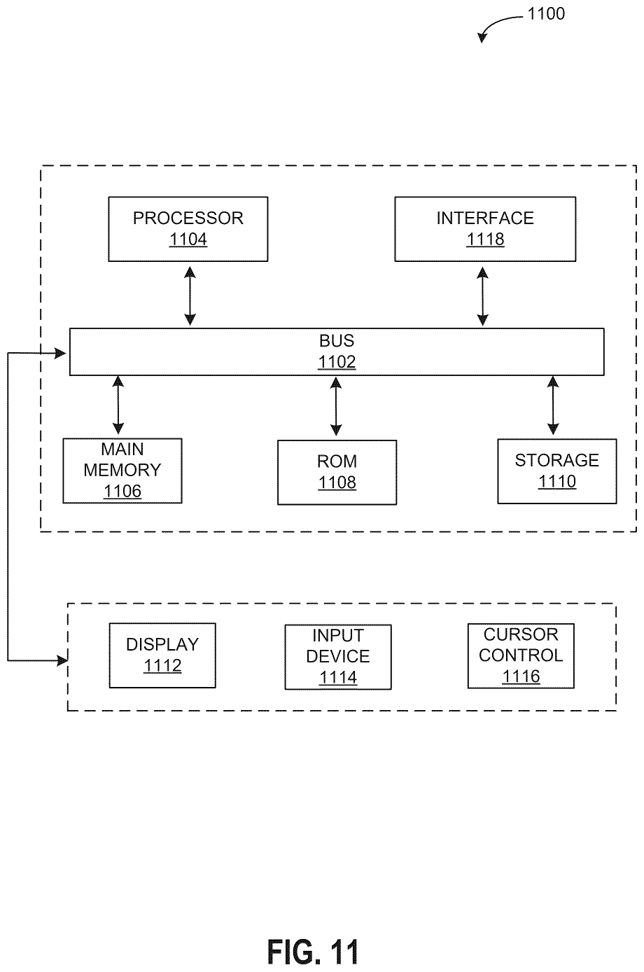

FIG. 11 depicts a block diagram of an example computer system 1100 in which various examples of the disclosed technology described herein may be implemented. Computer system 1100 includes bus 1102 or other communication mechanism for communicating information, one or more hardware processors 1104 coupled with bus 1102 for processing information. Hardware processor(s) 1104 may be, for example, one or more general purpose microprocessors.

Computer system 1100 also includes main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

Computer system 1100 further includes read only memory (ROM) 1108 or other static storage device coupled to bus 1102 for storing static information and instructions for processor 1104. Storage device 1110, such as a magnetic disk, optical disk, or USB thumb drive (Flash drive), etc., is provided and coupled to bus 1102 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 1100 may implement the techniques described herein using customized hard-wired logic, one or more ASICs or FPGAs, firmware and/or program logic which in combination with the computer system causes or programs computer system 1100 to be a special-purpose machine. According to one example of the disclosed technology, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

Computer system 1100 also includes interface 1118 coupled to bus 1102. Interface 1118 provides a two-way data communication coupling to one or more network links that are connected to one or more local networks. For example, interface 1118 may be an integrated services digital network (ISDN) card, cable modem, satellite modem, or a modem to provide a data communication connection to a corresponding type of telephone line. As another example, interface 1118 may be a local area network (LAN) card to provide a data communication connection to a compatible LAN (or WAN component to communicate with a WAN). Wireless links may also be implemented. In any such implementation, interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1118, which carry the digital data to and from computer system 1100, are example forms of transmission media.

Computer system 1100 can send messages and receive data, including program code, through the network(s), network link and interface 1118. In the Internet example, a server might transmit a requested code for an application program through the Internet, the ISP, the local network and interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
receiving time series data generated by a device;
providing, to a trained machine learning model, the time series data, the trained machine learning model generating a first prediction output of the time series data;
determining, using a pattern detection algorithm, a motif corresponding to a recurrent sequence of data entries;
replacing the recurrent sequence of data entries corresponding with the motif with a motif composition, the replacement generating a perturbed dataset comprising a subset of the time series data and the motif composition;
providing the perturbed dataset to the trained machine learning model, the trained machine learning model generating a second prediction output;
comparing the first prediction output and the second prediction output; and
providing an explanation of the comparison to the device.

2. The computer-implemented method of claim 1, wherein the motif corresponds with a pattern of time entries in the recurrent sequences of data entries that is repeated multiple times in the time series data.

3. The computer-implemented method of claim 1, wherein the motif is a first motif, and wherein the time series data comprises a second motif that corresponds with a different pattern than the recurrent sequence of data entries.

4. The computer-implemented method of claim 1, wherein the explanation of the comparison identifies a local explanation of the motif in the trained machine learning model, a global explanation of the trained machine learning model across various patterns, or cross-model explanation that have a consensus and divergence analysis.

5. The computer-implemented method of claim 1, wherein the comparison generates a Euclidean distance between the first prediction output and the second prediction output.

6. The computer-implemented method of claim 1, further comprising:
generating a visual representation of the comparison as a perturbation matrix; and
providing the perturbation matrix with the explanation to the device.

7. The computer-implemented method of claim 1, further comprising:
generating a visual representation of the comparison as a feature importance matrix; and
providing the feature importance matrix with the explanation to the device.

8. The computer-implemented method of claim 1, further comprising:
generating a visual representation of the comparison as a consistency matrix; and
providing the consistency matrix with the explanation to the device.

9. The computer-implemented method of claim 1, further comprising:
generating a visual representation of the comparison as a motif similarity matrix; and
providing the motif similarity matrix with the explanation to the device.

10. The computer-implemented method of claim 1, further comprising:
generating a visual representation of the comparison as a visualized heat map; and
providing the visualized heat map with the explanation to the device.

11. A computer system comprising:
a memory storing instructions; and
a processor communicatively coupled to the memory and configured to execute the instructions to:
receive time series data generated by a device;
provide, to a trained machine learning model, the time series data, the trained machine learning model generating a first prediction output of the time series data;
determine, using a pattern detection algorithm, a motif corresponding to a recurrent sequence of data entries;
replace the recurrent sequence of data entries corresponding with the motif with a motif composition, the replacement generating a perturbed dataset comprising a subset of the time series data and the motif composition;
provide the perturbed dataset to the trained machine learning model, the trained machine learning model generating a second prediction output;
compare the first prediction output and the second prediction output; and
provide an explanation of the comparison to the device.

12. The computer system of claim 11, wherein the motif corresponds with a pattern of time entries in the recurrent sequences of data entries that is repeated multiple times in the time series data.

13. The computer system of claim 11, wherein the motif is a first motif, and wherein the time series data comprises a second motif that corresponds with a different pattern than the recurrent sequence of data entries.

14. The computer system of claim 11, wherein the explanation of the comparison identifies a local explanation of the motif in the trained machine learning model, a global explanation of the trained machine learning model across various patterns, or cross-model explanation that have a consensus and divergence analysis.

15. The computer system of claim 11, wherein the comparison generates a Euclidean distance between the first prediction output and the second prediction output.

16. The computer system of claim 11, further comprising:
generating a visual representation of the comparison as a perturbation matrix, a feature importance matrix, a consistency matrix, a motif similarity matrix, or a visualized heat map; and
providing the visual representation with the explanation to the device.

17. A non-transitory computer-readable storage medium storing a plurality of instructions executable by a processor, the plurality of instructions when executed by the processor cause the processor to:
receive time series data generated by a device;
provide, to a trained machine learning model, the time series data, the trained machine learning model generating a first prediction output of the time series data;
determine, using a pattern detection algorithm, a motif corresponding to a recurrent sequence of data entries;
replace the recurrent sequence of data entries corresponding with the motif with a motif composition, the replacement generating a perturbed dataset comprising a subset of the time series data and the motif composition;
provide the perturbed dataset to the trained machine learning model, the trained machine learning model generating a second prediction output;
compare the first prediction output and the second prediction output; and
provide an explanation of the comparison to the device.

18. The non-transitory computer-readable storage medium of claim 17, wherein the motif corresponds with a pattern of time entries in the recurrent sequences of data entries that is repeated multiple times in the time series data.

19. The non-transitory computer-readable storage medium of claim 17, wherein the motif is a first motif, and wherein the time series data comprises a second motif that corresponds with a different pattern than the recurrent sequence of data entries.

20. The non-transitory computer-readable storage medium of claim 17, wherein the explanation of the comparison identifies a local explanation of the motif in the trained machine learning model, a global explanation of the trained machine learning model across various patterns, or cross-model explanation that have a consensus and divergence analysis.
